(19) United States
(12) Patent Application Publication
(10) Pub. No.: US 2007/0256880 A1
(43) Pub. Date: Nov. 8, 2007

(54) GOLF CAR STEEL WELDED TUBULAR FRAME

(75) Inventor: Landon N. Ball, North Augusta, SC (US)

Correspondence Address: HARNESS, DICKEY & PIERCE, P.L.C., P.O. BOX 828, BLOOMFIELD HILLS, MI, 48303, US

(73) Assignee: Textron, Inc., Providence, RI (US)

(21) Appl. No.: 11/381,957

(22) Filed: May 5, 2006

(51) Int. Cl. B62D 21/00; B60J 7/00

(52) U.S. Cl. 180/311; 280/781; 296/204

(57) ABSTRACT

A frame for small utility vehicles. The frame allows for modular assembly such that the same frame can be utilized to manufacture small utility vehicles of varying configurations. The frame is configured to allow efficient assembly such that limited movement of the frame is required during the attachment of the various components to assemble the small utility vehicle. The components can be attached directly to the frame from either a top or side of the frame.

### FIELD

The present disclosure relates to a frame assembly, for example, in golf cars and small utility vehicles.

### BACKGROUND

The statements in this section merely provide background information related to the present disclosure and may not constitute prior art.

Small utility vehicles can include: golf cars, shuttle personnel carriers, refreshment vehicles, industrial utility vehicles and/or trail utility vehicles. The small utility vehicles come in many different configurations that vary in both size and components or features that are present thereon.

Generally, the frame utilized in the small utility vehicle is prepared for the specific configuration of the small utility vehicle. The various components that are to be attached to the frame for that configuration are welded to the frame in the proper orientation and location. To inhibit corrosion of the frame and the components, the frame and welded-on components are then coated with an exterior rust-inhibiting coating, such as powder coating. With the coating thereon, the welding of additional components to the frame to change or enhance the configuration may compromise the coating, thereby resulting in premature failure or rusting of the frame and the effected components. Limiting of the frame to a specific configuration of a small utility vehicle requires different frames to be manufactured for the different configurations and thereby increases the cost. Moreover, this increases the number of parts that are required to be stocked to support the manufacture and repair of the different vehicle configurations that are offered.

The small utility vehicles use an electric motor or an internal combustion engine to power the vehicle. The frame is designed to accommodate both the electric motor and the internal combustion engine. The internal combustion engine may utilize different components or features that are not utilized with the electric motor. For example, the internal combustion engine may utilize a drive clutch. The frame, however, may hinder access to these various components that are utilized with the internal combustion engine and/or electric motor such that the engine and/or motor must be removed from the frame to perform maintenance and/or repairs. Removing the engine and/or electric motor to perform repairs increases the cost associated with the repair and the time necessary to perform the repair.

The assembling of these small utility vehicles typically requires the attaching of components to the top, sides or bottom of the frame. The attaching of these components to these various locations of the frame, however, requires the frame to be rotated, pivoted and/or inverted during various assembly steps. The movement of the frame to gain access to the various locations of the frame increases the time required to attach the components, thereby increasing the cost. Additionally, the movement of the frame requires specialized equipment to control the position and orientation of the frame to provide access to the various locations on the frame.

Therefore, it is desirable to provide a frame for a small utility vehicle that facilitates the assembly of different configurations in a cost-effective and efficient manner. Additionally, it would be desirable if the frame allowed easy access to the engine and/or motor to allow repair and/or maintenance work to be performed thereon.

### SUMMARY

A frame for small utility vehicles is provided in the present disclosure. The frame allows for modular assembly such that the same frame can be utilized to manufacture small utility vehicles of varying configurations. The frame is configured to allow efficient assembly such that limited movement of the frame is required during the attachment of the various components to assemble the small utility vehicle.

A small utility vehicle according to the present disclosure can include a frame having a pair of longitudinally-extending main members and at least one cross member attached to and extending between the main members. The frame can have a top, a bottom and sides. The frame can have a plurality of fastening features and a plurality of vehicle components can be attached to the frame. The fastening features allow the vehicle components to be repeatedly attached to and removed from the frame and all the vehicle components attached to the frame are attached from the top and the sides of the frame.

A modular system for production of small utility vehicles according to the present disclosure can include a universal frame having a plurality of fastening features on the main members and on at least one of the cross members. A first group of the fastening features can be arranged in a first orientation on the universal frame member while a second group of fastening features can be arranged in a second orientation on the universal frame member different than the first orientation. A first group of vehicle components of varying configuration can each have mounting features that align with the first group of fastening features thereby allowing any one of the vehicle components in the first group of vehicle components to be attached to the universal frame with the first group of fastening features. A second group of vehicle components of varying configuration can each have mounting features that align with the second group of fastening features thereby allowing any one of the vehicle components in the second group of vehicle components to be attached to the universal frame.

A small utility vehicle according to the present disclosure can include longitudinally-extending metallic main members having an interior surface and an exterior surface with at least one cross member attached to and extending between the main members. A plurality of apertures in the main members can extend from the exterior surface to the interior surface. An electro-coating layer can be disposed on an entirety of the interior and exterior surfaces of the main members and on the at least one cross member.

A small utility vehicle system according to the present disclosure can have a frame with longitudinally-extending main members that curve upwardly and then downwardly as the rear portion of the main members extend toward a rear end of the frame. A power unit can be coupled to the frame and can include a drive clutch coupled to an internal combustion engine with a retaining fastener. The retaining fastener can be located in a position corresponding to the vertically-curving portion of the main members such that the drive clutch retaining fastener is accessible from a side of the small utility vehicle and the drive clutch can be separated from the internal combustion engine without moving the entire power unit relative to the frame.

A method of assembling a small utility vehicle according to the present disclosure can include positioning vehicle components that are to be attached directly to a small utility vehicle frame on the small utility vehicle frame, aligning attachment features on the vehicle components with fastening features on the frame, and attaching the aligned vehicle components directly to the frame with fasteners that engage with the fastening features on the frame from either a top or side of the frame. All of the vehicle components that are attached directly to the frame can be done with fasteners that engage with the fastening features on the frame for either a top or side of the frame.

A method of assembling a small utility vehicle according to the present disclosure can include assembling a first small utility vehicle of a first configuration on a first one of a universal frame by selecting first and second vehicle components that correspond to the first configuration from respective first and second groups of vehicle components of varying configurations that all utilize the respective first and second groups of fastening features on the universal frame and attaching these first and second selected vehicle components to the first universal frame. The method can include assembling a second small utility vehicle of a second configuration different than the first configuration on a second one of the universal frames and can include selecting third and fourth vehicle components that correspond to the second configuration from the respective first and second groups of vehicle components of varying configurations and attaching the third and fourth selected vehicle components to the second universal frame.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a small utility vehicle configured as a golf car, in accordance with the present disclosure;

FIG. 2 is a front plan view of the small utility vehicle of FIG. 1;

FIG. 3 is a side plan view of the small utility vehicle of FIG. 1;

FIG. 4 is a bottom plan view of the small utility vehicle of FIG. 1;

FIG. 5 is a perspective view of a frame for a small utility vehicle in accordance with the present disclosure;

FIG. 6 is a side plan view of the frame of FIG. 5;

FIG. 7 is an enlarged partial side plan view of the frame of FIG. 6 with an internal combustion engine;

FIG. 8 is an exploded view of the frame of FIG. 5 showing various modular components that can be attached thereto;

FIGS. 9 and 10 are perspective views of an instrument panel support assembly in accordance with the present disclosure that may be attached to the frame of FIG. 5;

FIG. 11 is a perspective view of a seat support assembly in accordance with the present disclosure attached to a portion of the frame of FIG. 5;

FIG. 12 is an exploded view of the seat support assembly of FIG. 11;

FIG. 13 is a cross-sectional view along line 13-13 of FIG. 5 showing a threaded insert that can be utilized in the frame of FIG. 5 in accordance with the present disclosure;

FIG. 14 is an enlarged partial view of a front portion of the frame of FIG. 5 showing a prevailing-torque locking nut welded to a component of the frame in accordance with the present disclosure;

FIG. 15 is a partial perspective view of a rear portion of the frame of FIG. 5 showing the rear bumper attached thereto in accordance with the present disclosure; and

FIG. 16 is a perspective view of a small utility vehicle configured as an industrial utility vehicle with a storage bed, in accordance with the present invention.

### DESCRIPTION

The following description is merely exemplary in nature and is in no way intended to limit the present disclosure, application, or uses.

According to the present disclosure, a frame is utilized to allow modular assembly of small utility vehicles of varying configurations. The frame includes components or features that are utilized on all of the configurations and allows the addition of components that are unique to one or more of the configurations but not common to all. The frame has a corrosion-inhibiting protective coating both inside and out that can remain in tact regardless of the addition of the various modular components to assemble a small utility vehicle of a desired configuration. The frame is shaped to allow access to the components of the engine and/or motor utilized in the small utility vehicle. The frame can be configured to allow assembly of the small utility vehicle from a top and sides of the frame.

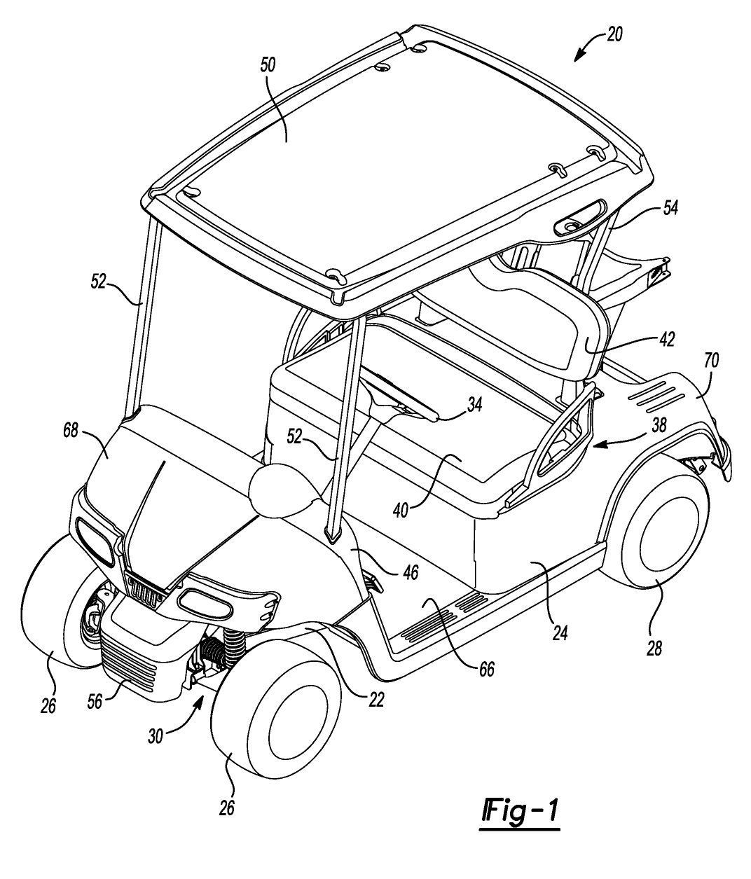

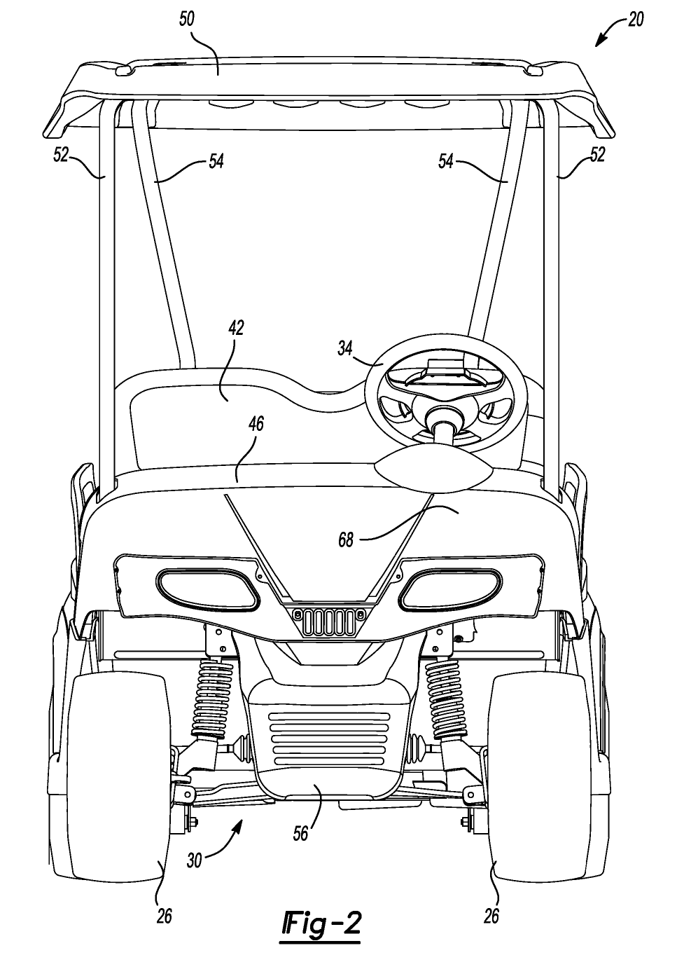

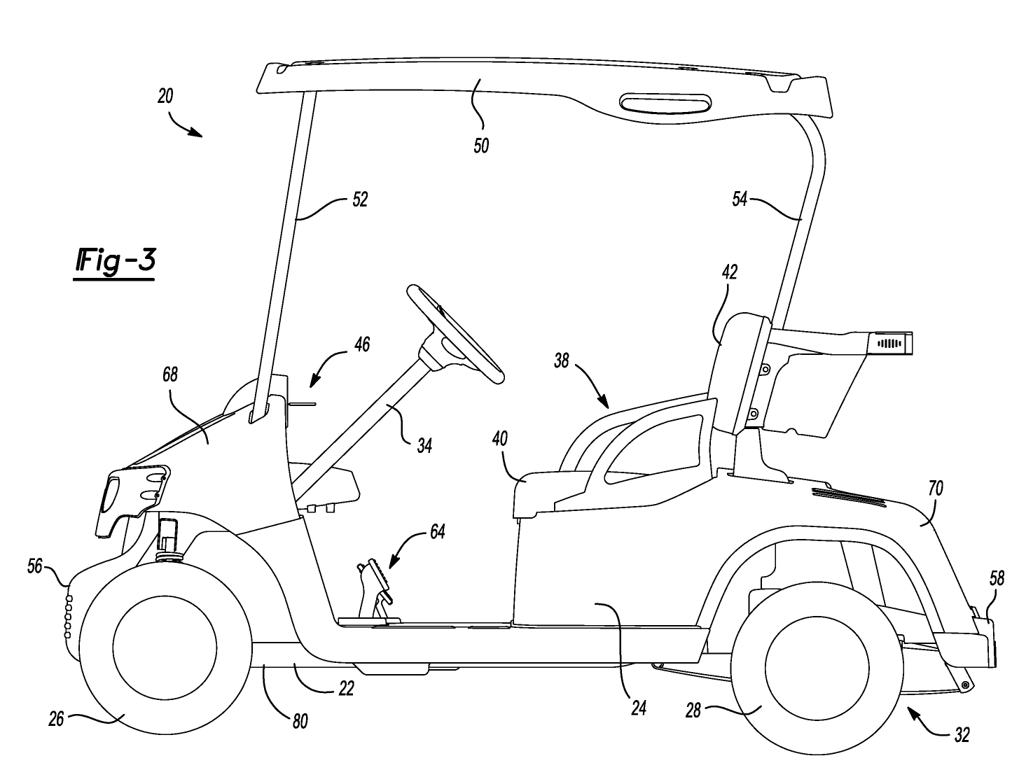

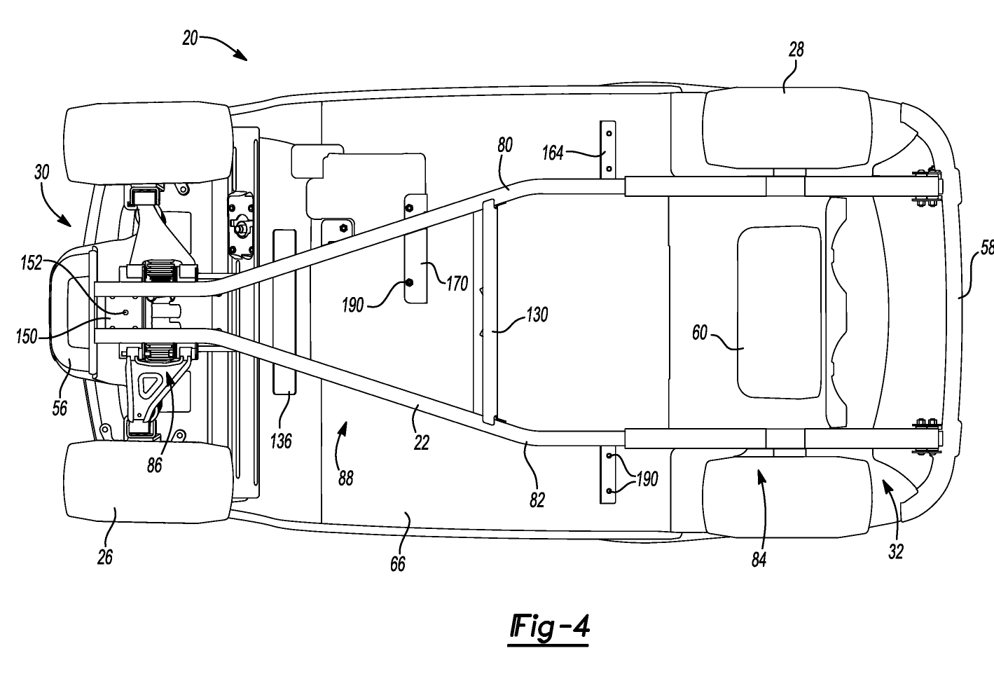

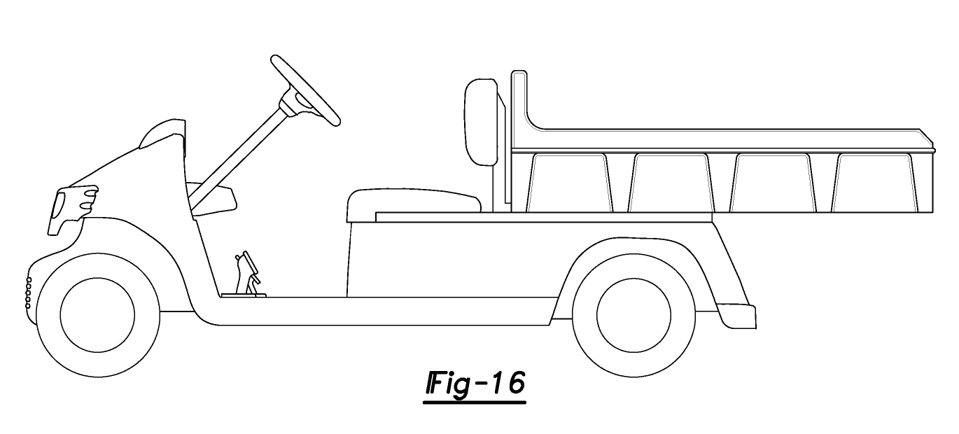

Referring to FIGS. 1-4, an exemplary small utility vehicle 20, in this case in the form of a golf car, according to the present disclosure is shown. As used herein, the term “small utility vehicle” includes, but is not limited to, shuttle personnel carriers, refreshment vehicles, industrial utility vehicles (such as that shown in FIG. 16), golf cars and/or trail utility vehicles. Vehicle 20 includes various components that are mounted to a frame 22, shown in FIG. 4, which may vary based upon the configuration or type of small utility vehicle to be formed. Vehicle 20 can include a body 24 supported from frame 22. Frame 22 can also support a plurality of wheels including steerable wheels 26 in addition to powered or driven wheels 28. A front suspension system 30 can be used to support steerable wheels 26. Driven wheels 28 are commonly connected to a rear structural portion of frame 22 with a rear suspension system 32. A steering mechanism 34, which commonly includes a steering wheel and a support post assembly, can also be included to provide the steering input to steerable wheels 26.

Vehicle 20 may also include a front seating area 38 including a bench seat 40 and a back support cushion 42. An instrument panel 46 can be included in a front portion of vehicle 20 and may house various components, such as instruments controlling the operation of vehicle 20 and/or indicating the operational status of vehicle 20 along with storage compartments and the like by way of non-limiting example.

A cover or roof 50 can be provided which is supported from either frame 22 or body 24 by front and rear canopy struts 52, 54. A wind screen or windshield (not shown) can also be provided which can be supported by each of the front canopy struts 52. Front and rear bumpers 56, 58 can be attached to frame 22. Other items that can be provided when vehicle 20 is in the form of a golf car include golf bag support equipment, accessory racks or bins, headlights, side rails, fenders or the like. Moreover, when vehicle 20 is configured as other types of vehicles, a rear-facing seat or multiple rows of seats may be included, a storage bed (tiltable or fixed), such as that shown in FIG. 16, may be attached to the rear portion of vehicle 20, beverage compartments may be attached to the rear portion of vehicle 20 and the like, by way of non-limiting example.

Vehicle 20 is commonly propelled by a power unit 60 (shown in FIG. 7), which is commonly disposed behind or below bench seat 40. Power unit 60 may be an internal combustion engine assembly or a battery and electric motor assembly. Power unit 60 drives driven wheels 28 and is typically attached to the drive axle interconnecting driven wheels 28 and frame 22. Power unit 60 enables driven wheels 28 to propel vehicle 20 in both a forward and rearward direction with steering provided by steerable wheels 26 via input from steering mechanism 34.

Vehicle 20 may also include a pedal assembly 64 that controls the output level of power unit 60 and the braking function of vehicle 20. Pedal assembly 64 is attached to frame 22 and extends through a floorboard 66 also attached to frame 22. Body 24 can also include a front fascia 68 along with side panels 70 to hide the internal components of vehicle 20 from view and provide a desired aesthetic appearance.

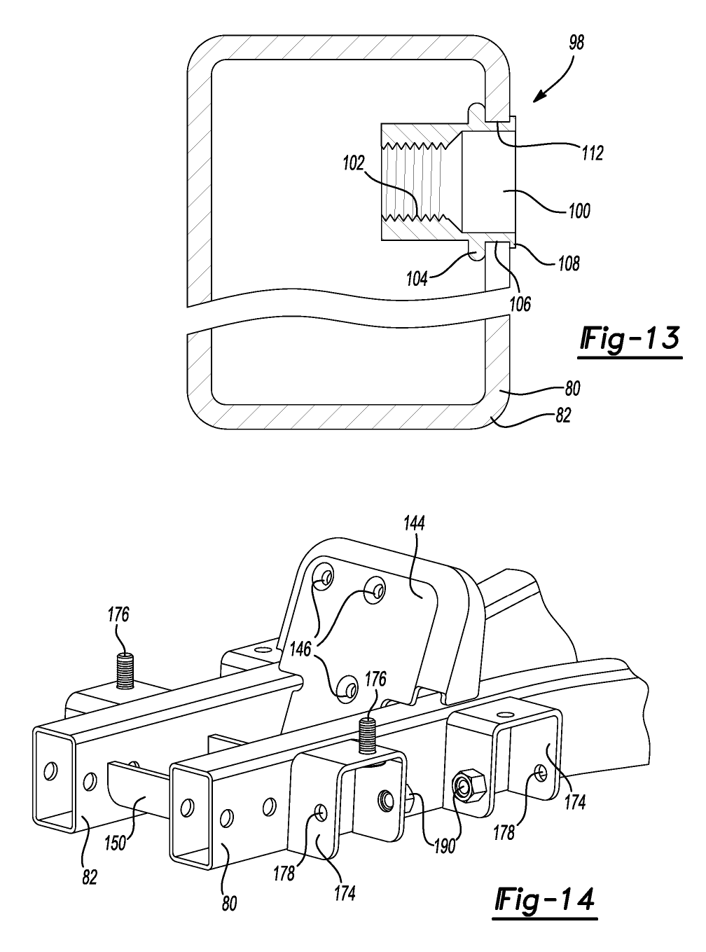

Referring now to FIGS. 4-6, details of frame 22, according to the present disclosure, are shown. Frame 22 is designed for modular construction, thereby enabling small utility vehicles of varying configurations to be made from frame 22. Frame 22 can include two elongated fore-and-aft extending main structural members 80, 82 that are transversely spaced apart. Main members 80, 82 can be bent into a desired configuration, such as that shown. Main members 80, 82 can be tubular and box-shaped in cross section, as shown in FIG. 13. Main members 80, 82 can be made from a variety of materials. For example, main members 80, 82 can be made of a structural steel, such as 1008 to 1020 steel. Main members 80, 82 can be formed by standard electrical-resistance welding or drawn over mandrel tubing.

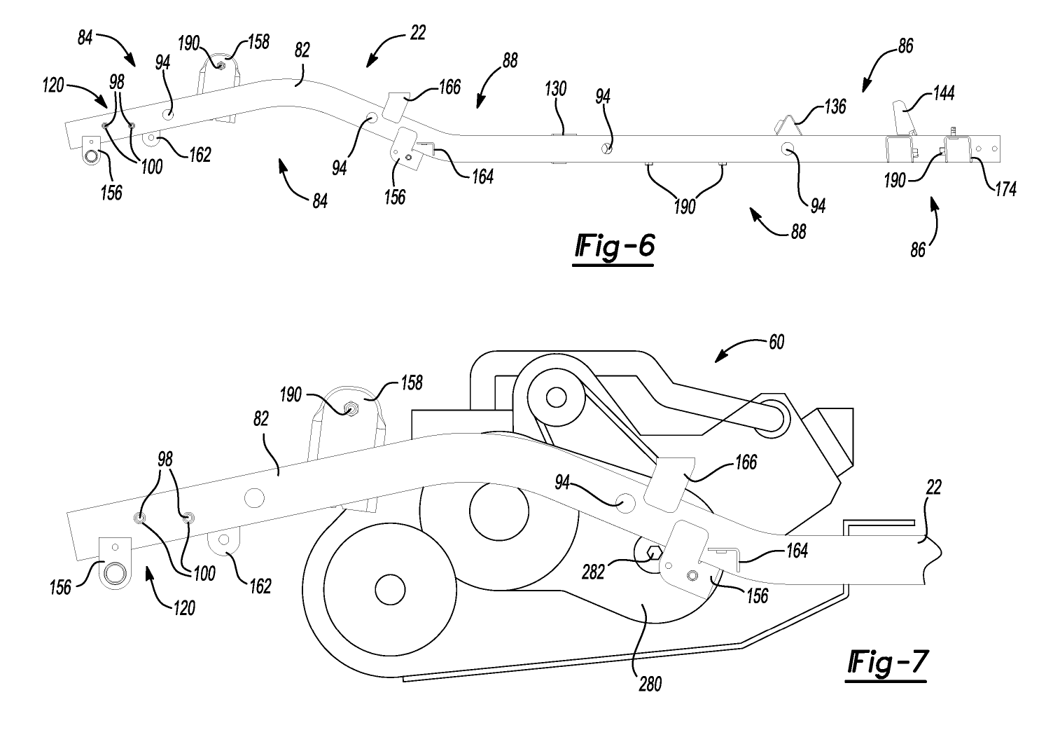

A rear portion 84 of main members 80, 82 can be parallel with one another. Front portions 86 of main members 80, 82 can also be parallel to one another. Intermediate portions 88 of main members 80, 82 can be non-parallel and approach one another as intermediate portions 88 extend from rear portions 84 toward front portion 86, as shown in FIG. 4. Front and intermediate portions 86, 88 of main members 80, 82 can be coplanar with one another, as shown in FIG. 6. Rear portions 84 of main members 80, 82 can be bent to have a vertical height that varies as rear portions 84 extend toward intermediate portions 88, as shown in FIG. 6.

In making frame 22, various holes or openings can be drilled or punched into main members 80, 82 to provide various features and capabilities for frame 22. A first set of openings 94 can be formed through opposing sides of each main member 80, 82 to facilitate the coating of main members 80, 82 with a rust-inhibiting coating, as described in more detail below. A second set of openings 98 can be formed into main members 80, 82 and only enter from one side of the main members. That is, openings 98 are blind openings wherein access to the opening from the interior is prevented by the opposing sides of the main members. Second set of openings 98 can be utilized to provide mounting points for the attachment of brackets and other modular components directly to main members 80, 82 which facilitate the use of frame 22 for small utility vehicles of varying configurations.

Openings 98 can receive clinch nuts or threaded inserts 100 therein. As shown in FIG. 13, threaded inserts 100 can be disposed within main members 80, 82 through openings 98 and are secured thereto by deforming threaded inserts 100 within the interior of main members 80, 82. Threaded inserts 100 include a female threaded portion 102, a deformed portion 104, a neck portion 106 and a flange portion 108. Initially, threaded insert 100 has a uniform exterior diameter from neck portion 106 through threaded portion 102 that allows threaded insert 100 to be inserted into opening 98. Flange portion 108 prevents threaded insert 100 from being inserted all the way through opening 98 and engages with the exterior surface of main members 80, 82. Threaded insert 100 is then deformed with a clinching tool by pulling threaded portion 102 toward flange portion 108, thereby causing a portion of the neck to deform and create deformed portion 104. Flange portion 108 and deformed portion 104 retain threaded insert 100 within opening 98. The exterior surface of neck portion 106 can be axially knurled to provide a series of ridges that engage with surface 112 of opening 98 and prevent rotation of threaded insert 100 within opening 98 when secured thereto. With threaded insert 100 securely attached to opening 98, other components or brackets can be attached to frame 22 with a bolt having threads that are complementary to threaded portion 102. Flange portion 108 can be dimensioned so that threaded insert 100 extends only slightly from the exterior surface of main members 80, 82. Suitable threaded inserts 100 include A.K. style threaded inserts available from AVK Industrial Products of Valencia, Calif. and D.K. style threaded inserts available from Textron Fastening Systems of Troy, Mich.

Threaded inserts 100 in main members 80, 82 allow brackets and other modules to be directly attached to frame 22 with complementary bolts and facilitate their installation. The threaded inserts 100 are installed into blind openings 98 in frame 22. The use of threaded inserts 100 eliminates the need for providing an access opening or hole in frame 22 to hold or secure a fastening component (i.e., a bolt, nut, etc).

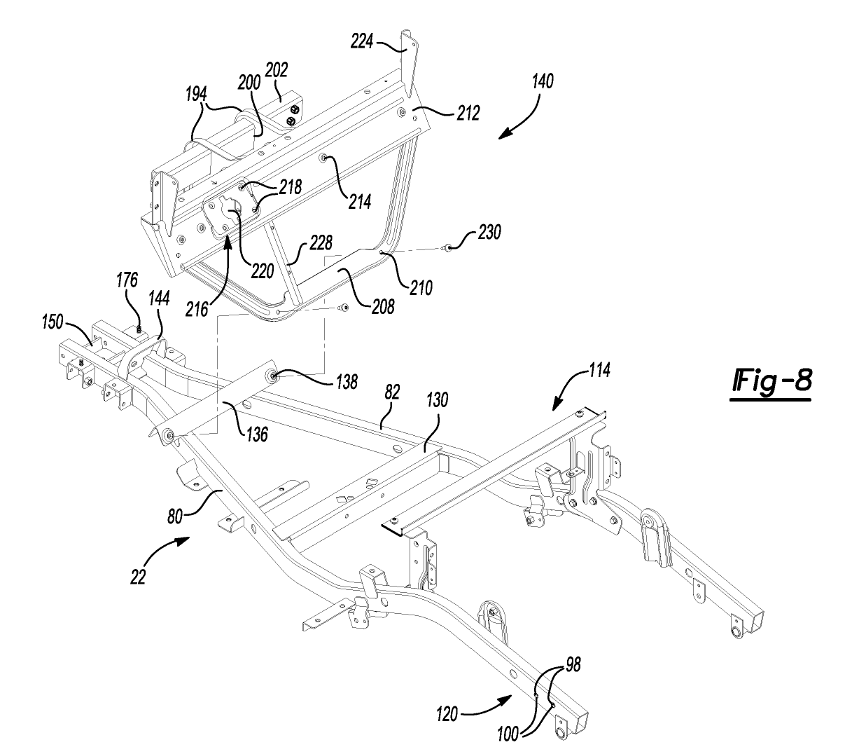

The use of threaded inserts 100 facilitates the modular construction of frame 22 and its use on vehicles 20 having multiple configurations. Threaded inserts 100 can be disposed at various locations along frame 22 and allow the attachment of various brackets that are designed for a particular configuration. The brackets for the different configurations can use the same threaded inserts 100 to attach to frame 22. The use of threaded inserts avoids the necessity of welding these brackets to frame 22 and thereby limiting the applicability of frame 22 to the particular configuration for which the bracket or component is designed. Threaded inserts 100 thereby provide a cost-effective method of attaching components, modules and other structures to the frame 22 without permanently welding them in place. It allows for the modular frame design which can be used on multiple vehicle configurations because the components that are not common to all the configurations for the vehicle are bolted in place using the same threaded inserts 100. This can also allow for the easy conversion of the vehicle from one configuration to another in the after market without welding, cutting and/or drilling frame 22. For example, threaded inserts 100 can be used to mount a seat support assembly 114 to frame 22, as shown in FIGS. 8, 11 and 12. Specifically, a group 118 of three openings 98 having threaded inserts 100 therein can be utilized on each main member 80, 82 to secure seat support assembly 114 (designed for a particular configuration) to frame 22. Similarly, a second group 120 of openings 98 on main members 80, 82 can be utilized for mounting rear vehicle assemblies, such as rear bumper 58 to frame 22 in one configuration, as shown in FIG. 15, or for attaching a utility bed, as shown in FIG. 16, or rear-facing seat supports or brackets in support thereof to frame 22 in other configurations of the small utility vehicle. Threaded inserts 100 can be attached to main members 80, 82 prior to or subsequent to the bending of main members 80, 82 into the desired configuration. Threaded inserts 100 can also be attached to main members 80, 82 prior to or subsequent to the addition of a rust-inhibiting coating to frame 22, as described below.

A variety of components or additional pieces are welded to main members 80, 82 to complete frame 22. These additional members are common to the various configurations of the small utility vehicles. That is, these components are utilized in all the configurations for which frame 22 is intended to be utilized. These welded-on components are attached to main members 80, 82 prior to applying the rust-inhibiting coating. As such, these added members are also coated with the rust-inhibiting coating, thereby forming a frame 22 that is entirely coated with a rust-inhibiting material, as described below. These various components that are welded to main members 80, 82 can be steel and formed by progressive die stamping, laser burning and bending, water cutting and bending and the like.

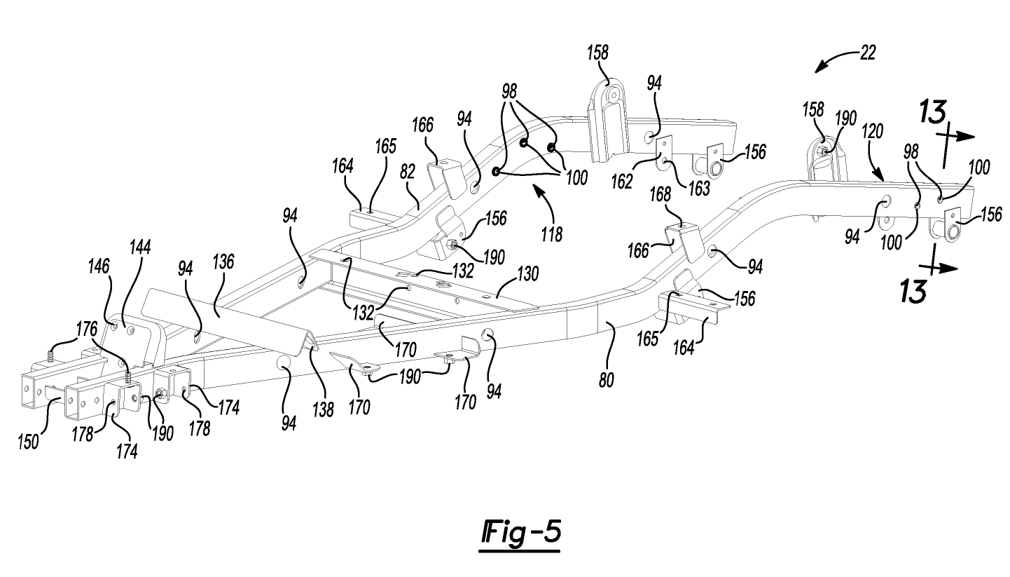

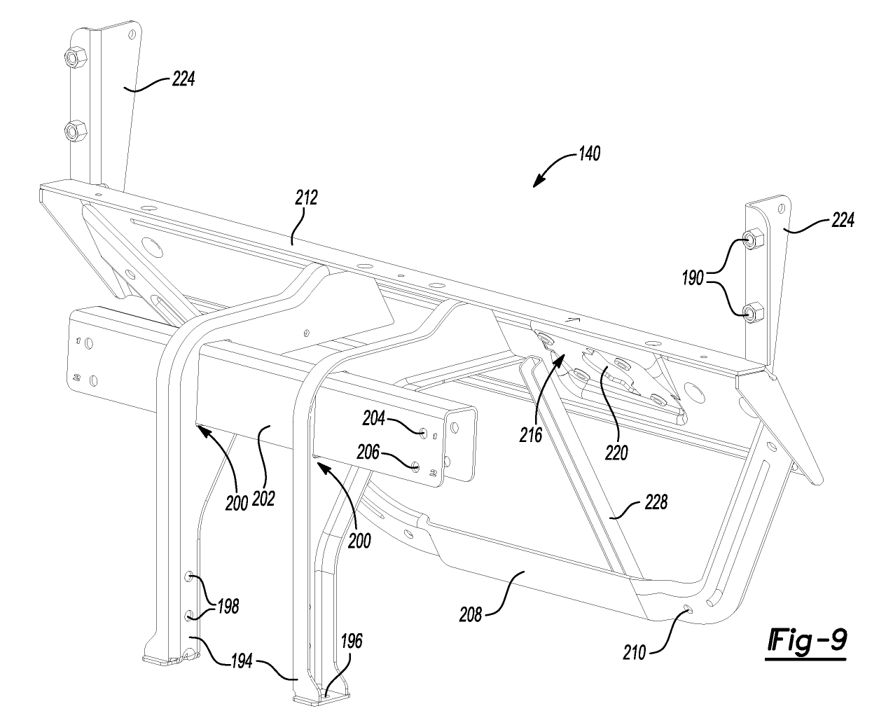

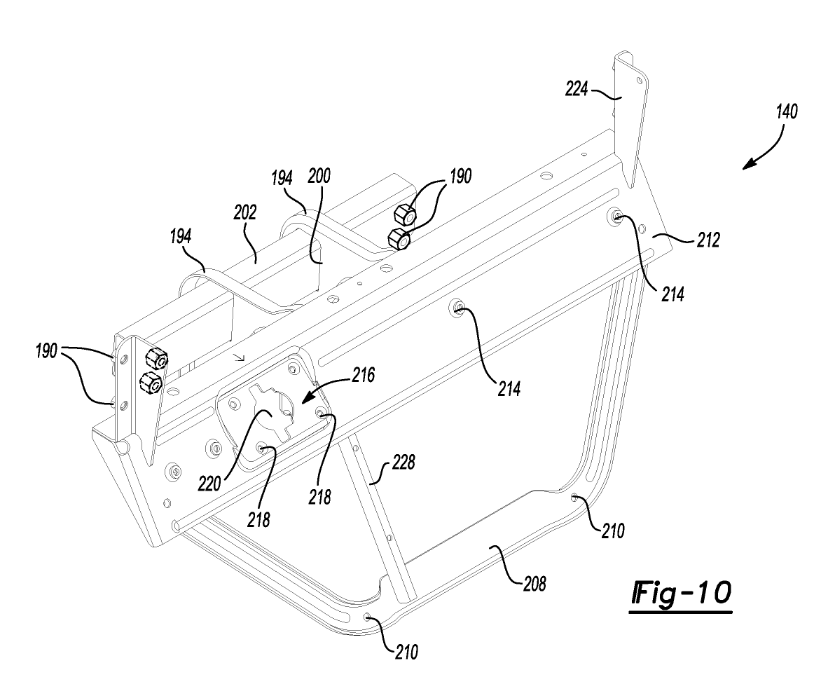

A first cross member 130 can be welded to main members 80, 82 between intermediate portions 88, as shown in FIGS. 4 and 5. First cross member 130 can be C-shaped in cross section and can supply structural rigidity and support for frame 22. First cross member 130 can have a plurality of extruded holes or openings 132 for receiving self-tapping fasteners to secure various components of vehicle 20 thereto. A second cross member 136 can be welded to the top surface of intermediate portions 88 of main members 80, 82 near front portions 86. Second cross member 136 can be V-shaped in cross section. Second cross member 136 can include various holes or openings 138 to removably attach an instrument panel (IP) support assembly 140 (shown in FIGS. 8-10) to frame 22, as described below.

A third cross member 144 can be welded to front portion 86 of main members 80, 82. Third cross member 144 can include a plurality of openings 146 and can be used to mount a steering rack to frame 22. The steering rack can be coupled to steering mechanism 34 to enable steerable wheels 26 to be turned to cause vehicle 20 to move in a desired direction. A fourth cross member 150 can be welded to front portions 86 of main members 80, 82 and extend therebetween. Fourth cross member 150 can provide structural support and rigidity for front portion 86 of frame 22. Fourth cross member 150 can include a vertically-extending opening 152 (shown in FIG. 4) that can be used to attach a tow-bar attachment (not shown) to vehicle 20. The tow-bar attachment allows vehicle 20 to be towed by another vehicle. Fourth cross member 150 can allow the tow-bar attachment to be attached directly to frame 22 as opposed to being attached to the front axle of vehicle 20.

Additional brackets and their components can be welded to one of main members 80, 82 to facilitate the attachment of other structures or components to frame 22. These other members are utilized in each of the various configurations for which frame 22 can be utilized. Thus, these other members are welded to the frame as they can be utilized regardless of what configuration of vehicle is made from frame 22.

A pair of rear suspension mounts 156 can be attached to the rear portion 84 of each main member 80, 82. Suspension mounts 156 enable components of rear suspension system 32, such as a leaf spring, to be coupled to frame 22. A rear shock absorber mount 158 can be welded to the rear portions 84 of each main member 80, 82. Rear shock absorber mounts 158 can be utilized to mount the top of the shock absorber utilized in rear suspension system 32 to frame 22.

Brackets 162 can be welded to rear portions 84 of main members 80, 82 and can have an opening 163 therein. Brackets 162 can be used to mount a rear vehicle assembly, such as rear bumper 58 to frame 22 in one configuration, as shown in FIG. 15, or for attaching a utility bed, as shown in FIG. 16, or rear-facing seat supports or brackets in support thereof to frame 22 in other configurations of the small utility vehicle. Brackets 162 can include a prevailing-torque locknut (not shown) aligned with opening 163 to facilitate the attachment of rear vehicle assembly thereto from the side of frame 22. A second set of brackets 166 can be welded to rear portion 84 of main members 80, 82 and can extend upwardly therefrom. Brackets 166 have an opening 168 therein that can be used to attach removable components to frame 22. For example, brackets 166 can be used to mount a battery tray to frame 22 when an electric motor is utilized as the power unit 60. The battery tray can also be attached to openings 132 in first cross member 130. Another set of brackets 164 can be attached to the outer sides of rear portions 84 of main members 80, 82. Brackets 164 can include one or more openings 165 therein. Brackets 164 can be used to attach floorboard 66 to frame 22.

A group of brackets 170 can be attached to intermediate portion 88 of main member 80. Brackets 170 can be used to attach pedal assembly 64 to frame 22. Another group of brackets 174 can be welded to the sides of front portions 86 of main members 80, 82. Brackets 174 may be clevis mounts used to attach A-arms of front suspension system 30 to frame 22. The front pair of brackets 174 can include upwardly-extending studs 176 to facilitate the locating and attachment of IP support assembly 140 to frame 22, as described below. Brackets 174 can include openings or holes 178 to facilitate the attachment of front suspension system 30 thereto.

While the various brackets and components that are shown as being attached to frame 22 are described with reference to specific purposes and/or functions, it should be appreciated that these members can provide additional functions or capabilities and can include additional openings, holes and/or fasteners attached thereto to provide the functionality and mounting capabilities desired.

To facilitate the attachment of various modular components and/or assemblies to frame 22, the brackets and attachments described above can include prevailing-torque locknuts 190 welded thereto. Prevailing-torque locknuts can include built-in locking features that develop a full locking action as these nuts are engaged with the threads of a bolt. The prevailing-torque locknuts can rely on a distortion of the nut thread or shape to create an interference fit with the bolt being inserted therein. The prevailing-torque locknuts inhibit the removal of the fasteners that are inserted therein, thus preventing inadvertent loosening or disconnection of the components that are attached to frame 22 through the use of prevailing-torque locknuts 190. With the prevailing-torque locknuts 190 welded in place, an operator assembling vehicle 20 does not need to hold the locknut in place to prevent the locknut from rotating during the assembly process. Additionally, the prevailing-torque locknuts 190 can be easily attached to the brackets and components through an automated process that automatically feeds the prevailing-torque locknuts and welds it in place. Thus, the use of the prevailing-torque locknuts 190 facilitates the assembly of vehicle 20 while also providing the locking feature of preventing inadvertent loosening or detachment of a component from the bracket or component to which the prevailing-torque locknut 190 is welded.

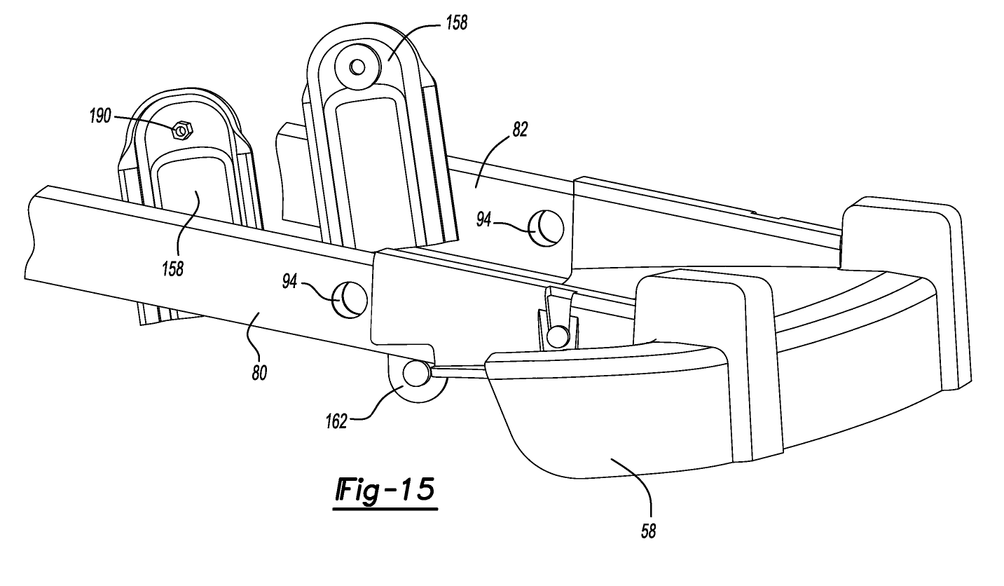

Prevailing-torque locknuts 190 can be utilized on a variety of the brackets and components of vehicle 20 and frame 22. For example, the prevailing-torque locknuts 190 can be attached to front clevis brackets 174 to facilitate the attachment of front suspension system 30 to frame 22, as shown in FIGS. 5 and 14. Prevailing-torque locknuts 190 can also be utilized on brackets 170 to facilitate the attachment of pedal assembly 64 thereto. Additionally, prevailing-torque locknuts 190 can also be utilized on brackets 156 to facilitate the attachment of rear suspension system 32 to frame 22. Prevailing-torque locknuts 190 can also be utilized on rear shock absorber mounts 158 to facilitate the attachment of rear shock absorbers thereto. It should be appreciated that prevailing-torque locknuts 190 can be welded to additional components, such as brackets 162, that are attached to frame 22 and/or additional components that are used to assemble vehicle 20, as desired, to advantageously provide secured locking fasteners that do not require an assembly worker to prevent rotation thereof when assembling vehicle 20.

Frame 22 can be provided with a rust-inhibiting coating after the attachment of the previously-described brackets and cross members and after the attachment of threaded inserts 100 and prevailing-torque locknuts 190. As stated above, a first set of openings 94 can be made in main members 80, 82 to facilitate the application of the rust-inhibiting coating. Frame 22 can be electrocoated (e-coated) with various corrosion-inhibiting particles that form a layer of a desired thickness along frame 22. Openings 94 are sized and positioned to allow the e-coating to reach the internal portions of main members 80, 82 so that frame 22 is entirely coated both inside and out. The spacing and size are selected so that a complete and thorough coating of the interior of main members 80, 82 is achieved for the particular electrocoating process utilized. As such, the size, numbering and spacing can vary from that shown. The e-coating thereby provides a rust-inhibiting layer along the entirety of frame 22 including both the inside surface and the exterior surface. The e-coating covers both the main members 80, 82, the prevailing-torque locknuts 190, the various brackets and mounts welded to frame 22, the threaded inserts 100 and the like. The thickness of the corrosion-inhibiting coating can be selected so that a desired level of corrosion resistance is achieved. For example, the coating can have a thickness of 0.004 inches. This thickness facilitates the coating of the threads in threaded inserts 100 and in the prevailing-torque locknuts 190 without hindering their ability to perform their functions.

Frame 22 can be dipped into a liquid bath containing the corrosion-inhibiting particles with an electric charge applied to the frame. When the frame is removed from the bath, air jets can force air to blow along the frame to avoid pooling or puddling and to remove the excess coating from the frame. Suitable corrosion-inhibiting products include those available from PPG Industries of Pittsburgh, Pa.

With frame 22 fully coated and having the above-described brackets and components attached thereto, it can then be utilized to assemble a vehicle of a desired configuration. One modular component that can be attached to frame 22 is IP support assembly 140, shown in FIGS. 8-10. IP support assembly 140 can include a pair of front structural members 194 that can be generally C-shaped in cross section. The lower portion of the structural member 194 can each include a foot having an opening 196 that can be configured to fit over stud 176 on front clevis brackets 174 to secure IP support assembly 140 to frame 22. The vertically-extending portions of front structural members 194 can also include a plurality of openings 198 which can be used to mount portions of the front bumper 56 for the particular configuration desired for vehicle 20. In the area where the vertical and horizontal portions of front structural members 194 meet, an opening 200 can be located to receive a cross member 202 therein. Cross member 202 can extend horizontally in a transverse orientation across vehicle 20 and can be C-shaped in cross section. Cross member 202 can include upper and lower sets of openings 204, 206 to provide two different mounting positions for the struts of front suspension system 30. Prevailing-torque locknuts 190 can be attached to cross member 202 to facilitate the attachment of front suspension system 30. The two distinct mounting positions allow for differing configurations for vehicle 20. A first one of the mounting positions can be used for vehicle 20 having a standard height while the other of the mounting positions can be used for vehicle 20 having a raised or elevated height. With this capability, IP support assembly 140 can be utilized for multiple configurations of vehicle 20.

IP support assembly 140 can also include a rear structural member 208 that is generally U-shaped and extends transversely across vehicle 20. Rear structural member 208 can include a pair of openings 210 that provide additional mounting locations to attach IP support assembly 140 to frame 22, as described below. IP support assembly 140 can also include an instrument panel (IP) bracket 212 that can extend transversely across vehicle 20. IP bracket 212 can be attached to the upwardly-extending leg portions of rear structural member 208 and to the horizontal portions of front structural members 194. IP bracket 212 can include a plurality of raised extrusions 214 for receiving a fastener (not shown) to secure instrument panels (not shown) and/or portions of floorboard 66 thereto. IP bracket 212 can also include a mounting feature or section 216 which can be used to mount steering mechanism 34 thereto. Mounting feature 216 can include a plurality of openings 218 for receiving fasteners (not shown) to secure steering mechanism 34 to IP support assembly 140. The steering shaft of steering mechanism 34 can extend through a large opening 220 in mounting feature 216. Mounting feature 216 can enable a multi-angled steering column assembly to be mounted thereto. An exemplary multi-angle steering column assembly is that disclosed in co-pending U.S. Provisional Patent Application Ser. No. 60/744,465 filed Apr. 7, 2006, entitled “Multi-Angle Steering Column Assembly” and assigned to the assignee of the present invention, the disclosure of which is incorporated herein by reference.

A pair of canopy strut brackets 224 can be attached to IP bracket 212. Canopy strut brackets 224 can be used to secure front canopy struts 52 to IP support assembly 140. Canopy strut brackets 224 can include a pair of prevailing-torque locknuts 190 welded thereto to facilitate the attachment of front canopy struts 52 to canopy strut brackets 224. A vertically-extending brace 228 can be attached to the lower portion of rear structural member 208 and IP bracket 212 adjacent mounting feature 216. Brace 228 can be C-shaped in cross section and can provide additional rigidity and support to IP support assembly 140 to handle the loading imparted on IP support assembly 140 through steering mechanism 34. Each of these components of IP support assembly 140 may include additional openings and/or features to enable the attachment of additional components of vehicle 20 thereto.

Each of the components of IP support assembly 140 can be made of steel and formed by progressive die stamping. The various components can be welded together, such as by mig welding. IP support assembly 140, once assembled, is electrocoated with a rust-inhibiting coating.

The manufacture of IP support assembly 140, as a modular unit that is subsequently attached to frame 22, facilitates the use of frame 22 for multiple configurations of vehicle 20. That is, frame 22 provides common mounting points that an IP support assembly regardless of configuration and design can utilize to attach to frame 22. To attach IP support assembly 140 to frame 22, front structural members 194 can be positioned on front portions 86 of main members 80, 82 with studs 176 extending through openings 196. Studs 176 thereby provide an aligning feature for IP support assembly 140 that facilitates the aligning of openings 210 in rear structural member 208 with openings 138 in second cross member 136. In addition to the aligning function of studs 176, the studs 176 can also serve to retain IP support assembly 140 in the appropriate orientation while fasteners 230 are used to secure rear structural member 208 to second cross member 136. Nuts (not shown) can be secured to studs 176 to attach front structural members 194 to frame 22. This same assembly technique can be utilized for IP support assemblies of varying configurations to produce a vehicle of a desired configuration. It should be appreciated that while IP support assembly 140 is shown for a particular configuration, IP support assembly 140 can take various additional forms and/or orientations to meet the configuration for the desired vehicle. With IP support assembly 140 being a modular unit that is attached to frame 22 during the assembly of vehicle 20, IP support assembly 140 can be manufactured at a remote location from frame 22 and/or outsourced to a vender to produce. The modular use of an IP support assembly thereby facilitates efficient manufacture of a vehicle 20 and allows the use of a single common frame 22 for vehicles 20 of multiple configurations.

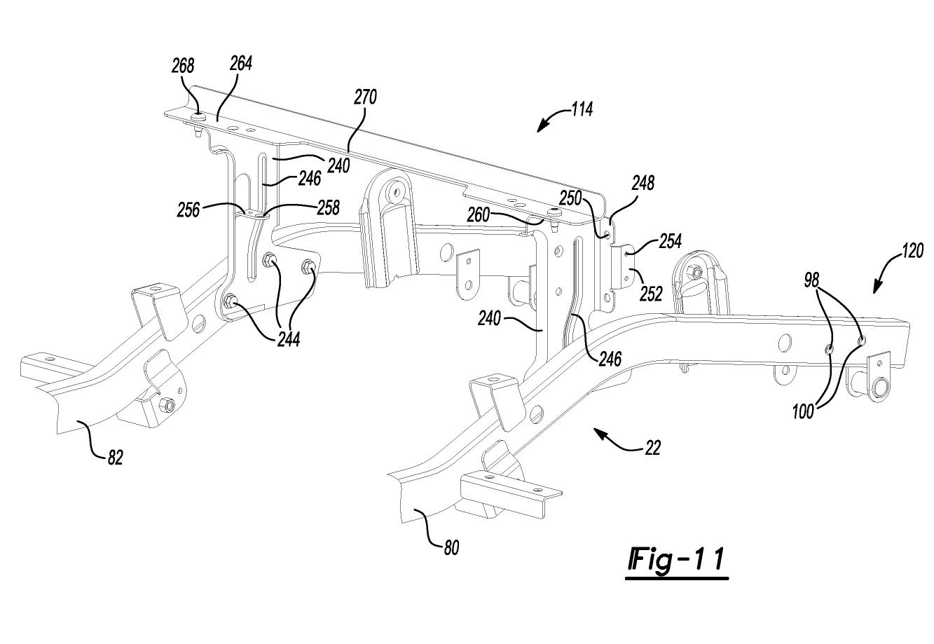

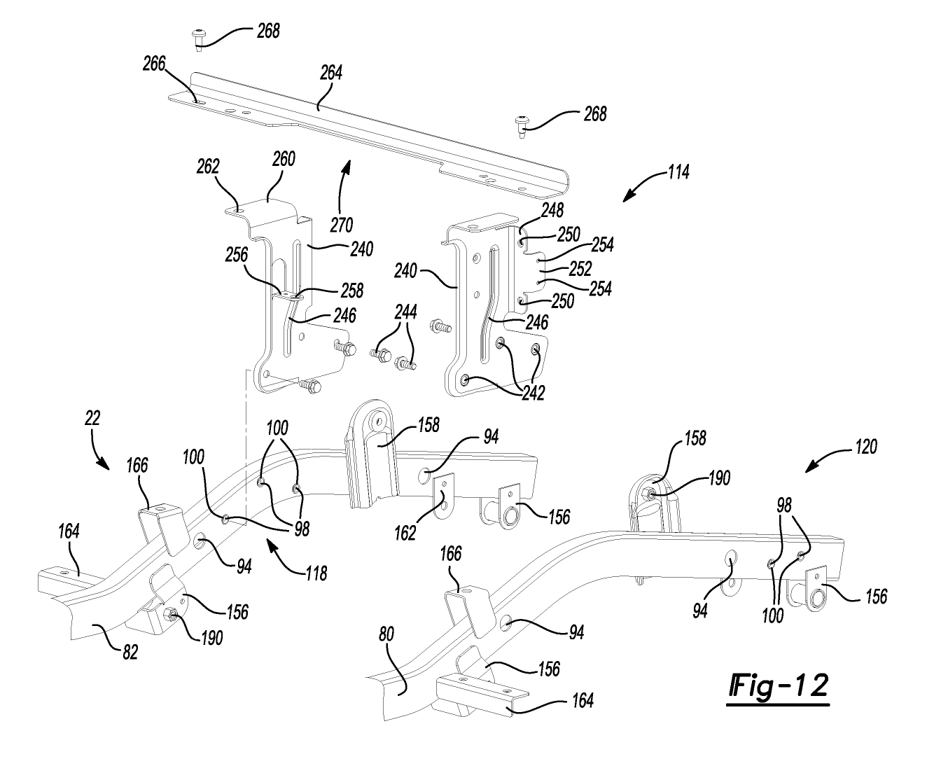

Another modular assembly that can be attached to frame 22 is seat support assembly 114, as shown in FIGS. 11 and 12. Seat support assembly 114 can also come in various configurations to match the desired configuration for vehicle 20. Regardless of the configuration of seat support assembly 114, the same mounting locations to frame 22 are utilized. Seat support assembly 114 can support the rear body of vehicle 20 and the rear portion of front seating area 38.

Seat support assembly 114 can include a pair of brackets 240 that can each include a plurality of openings 242 configured to received fasteners 244 in order to secure seat support assembly 114 to frame 22. Openings 242 align with openings 98 and the threaded inserts 100 therein. Fasteners 244 can be secured to threaded inserts 100 thereby attaching seat support assembly 114 to frame 22.

Brackets 240 can include a vertically-extending stiffening rib 246 to provide additional stiffness and rigidity to brackets 240. Brackets 240 can include a flange portion 248 having a pair of openings 250 therein. Flange 248 and openings 250 can be used to attach rear canopy struts 54 to seat support assembly 114. Flange 248 can also include an extension 252 with openings 254 therein. Extension 252 and openings 254 can be used to attach an inner fender liner to seat support assembly 114. One or more brackets 240 may also include a horizontal extension 256 with an opening 258 therein. Extension 256 and opening 258 can be used to attach a gas tank to seat support assembly 114 when power unit 60 is an internal combustion engine.

The top portions of brackets 240 can include horizontal extensions 260 with an opening 262 therein. Extension 260 and opening 262 can be utilized to attach a cross member 264 thereto. Cross member 264 can have openings 266 that align with openings 262 on extensions 260 to allow fasteners 268 to be used to attach cross member 264 to brackets 240. Cross member 264 can have a generally L-shaped cross section and can provide a supporting surface for components of vehicle 20, such as the rear portion of front seating area 38. Cross member 264 can have a cut-out section or area of reduced surface area 270 that can be used to facilitate the adding of fluids, such as water, to the batteries when power unit 60 is a battery and electric motor assembly.

Seat support assembly 114 can thereby be utilized on vehicle 20 using a power unit 60 that is either an internal combustion engine assembly or a battery and electric motor assembly. The modular nature of seat support assembly 114 enables different seat support assemblies to be utilized depending upon the desired configuration of vehicle 20. For example, brackets 240 can take a variety of forms to provide the desired features and retention capabilities for the components that are to be utilized with the particular configuration for the vehicle. The brackets can utilize the same second set of openings 98 and the threaded inserts 100 therein to mount to frame 22. Brackets 240 and cross member 264 can be electrocoated with a rust-inhibiting coating, if desired. Additionally, cross member 264 can be welded to brackets 240 in lieu of the use of fasteners 268. Brackets 240 and cross member 264 can be made of steel and can be formed by progressive die stamping.

The use of a modular seat support assembly 114 facilitates the repair and/or alteration of vehicle 20. Thus, in the event that seat support assembly 114 is damaged, the various components that comprise seat support assembly 114 can be individually removed and replaced. This capability would not be present when seat support assembly is welded to frame 22. Moreover, if it is desired to change the configuration of vehicle 20 in the after market, seat support assembly 114 can be easily removed therefrom and replaced with the components that correspond to the desired configuration. Thus, use of modular seat support assembly 114 that can be configured for a desired configuration of the vehicle can facilitate the production of vehicles 20 of a desired configuration.

The configuration of frame 22 is designed to advantageously facilitate the assembly of small utility vehicles of varying configurations. Frame 22 can be configured so that the various components that are to be attached thereto can be attached solely from the top and/or side of frame 22. As used herein, the term “side” means the driver's side, passenger's side, front side or rear side of vehicle 20. Additionally, the term “top” means from above frame 22 as it is nominally positioned within a small utility vehicle. Thus, when it is stated that frame 22 can allow assembly of components thereon from the top or sides, it means that no fasteners have to be installed onto frame 22 from below or underneath the frame to attach the components that correspond to the desired configuration of small utility vehicle. As such, frame 22 does not need to be inverted, flipped or elevated to gain access to the underside of frame 22 for the attachment of fasteners from below.

For example, as best shown in FIG. 5, all of the various brackets and features on frame 22 that allow other components to be attached thereto are accessible from the side or top. Seat support assembly 114 can attach to frame 22 from the side. IP support assembly 140 can attach to frame 22 from the top. Rear suspension system 32 and the accompanying shocks can attach to mounts 156, 158 from the side. Rear bumper 58 can attach to frame 22 from the side. Front suspension system 30 can attach to IP support assembly 140 and clevis brackets 174 from the top and side. The steering rack and steering mechanism 34 can attach to third cross member 144 from the side. Front bumper 56 can attach to frame 22 and IP support assembly 140 from the side. Pedal assembly 64 can attach to frame 22 from the top. Floorboard 66 can attach to frame 22 from the top. The battery tray (not shown) can attach to frame 22 from the top. Additional components can attach to IP support assembly 140 and seat support assembly 114 from the top and/or the side. Additionally, the remaining brackets or mounts 162, 164, 166 can all have the components attached thereto from either the top or side. Thus, frame 22 can be configured to allow for all top down and/or side assembly wherein no fasteners have to be installed onto the frame from below.

Referring now to FIG. 7, frame 22 can be configured to facilitate repair to power unit 60. For example, power unit 60 can be an internal combustion engine that includes a drive clutch 280 that is attached to power unit 60 with a retaining bolt 282. Rear portion 84 of main members 80, 82 can curve upwardly to allow driven wheels 28 and the rear suspension system 32 to which they are attached to be in a desired orientation for vehicle 20. The curvature of rear portion 84 can be configured to allow access to drive clutch retaining bolt 282 so that drive clutch 280 can be serviced and/or replaced without the necessity of removing power unit 60 or dropping power unit 60 down from within frame 22. That is, frame 22 can be shaped to allow easy accessibility to the drive clutch retaining bolt 282 so that the drive clutch 280 can be easily removed without requiring additional disassembly of power unit 60. This curvature can be a tremendous help in increasing the serviceability of a vehicle 20 manufactured from a frame 22. Such a design facilitates the maintenance or repair of drive clutch 280 thereby reducing the cost of servicing vehicle 20.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A small utility vehicle comprising:
a frame including a pair of longitudinally extending main members and at least one cross member attached to and extending between the main members, the frame having a top, a bottom, and sides;
a plurality of fastening features on the frame; and
a plurality of vehicle components attached to the frame,
wherein the fastening features allow the vehicle components to be repeatedly attached to and removed from the frame and all of the vehicle components attached to the frame are attached from the top and the sides of the frame.

2. The small utility vehicle of claim 1, wherein the fastening features include threaded inserts, prevailing torque weld nuts, brackets, and threaded studs.

3. The small utility vehicle of claim 1, wherein the vehicle components attached to the frame include an instrument panel support assembly, a seat support assembly, a pedal assembly, a front suspension system, a rear suspension system, a power unit, a drive system, a floorboard, and a rear vehicle assembly.

4. The small utility vehicle system of claim 1, wherein the small utility vehicle can be assembled into a variety of configurations, the vehicle components come in a variety of configurations that correspond to the configuration of the small utility vehicle and all of the vehicle components that are attached to the frame are attached from the top and the sides of the frame regardless of the particular configuration of the small utility vehicle.

5. A golf car including the small utility vehicle system of claim 1.

6. A modular system for production of small utility vehicles of varying configurations, the modular system comprising:
a universal frame including a pair of longitudinally extending main members, a plurality of cross members attached to and extending between the main members, and a plurality of fastening features on the main members and on at least one of the cross members;
a first group of the fastening features arranged in a first orientation on the universal frame member;
a second group of the fastening features arranged in a second orientation on the universal frame member different than the first orientation;
a first group of vehicle components of varying configuration, each of the vehicle components in the first group of vehicle components having mounting features that align with the first group of fastening features thereby allowing any one of the vehicle components in the first group of vehicle components to be attached to the universal frame with the first group of fastening features; and
a second group of vehicle components of varying configuration, each of the vehicle components in the second group of vehicle components having mounting features configured to align with the second group of fastening features thereby allowing any one of the vehicle components in the second group of vehicle components to be attached to the universal frame.

7. The modular system of claim 6, wherein the first group of vehicle components includes a first group of brackets of varying configuration and the second group of vehicle components includes a second group of brackets of varying configuration.

8. The modular system of claim 7, wherein the first group of brackets includes instrument panel support brackets and the second group of brackets includes front seat support brackets.

9. The modular system of claim 6, wherein the first and second groups of vehicle components include at least two of instrument panel support assemblies of varying configurations corresponding to the varying configurations of the vehicle, seat support assemblies of varying configuration corresponding to the varying configurations of the vehicle, and rear vehicle assemblies of varying configuration corresponding to the varying configurations of the vehicle.

10. The modular system of claim 6, wherein the varying configurations of the small utility vehicle include golf cars, shuttle personnel carriers, refreshment vehicles, industrial utility vehicles and trail utility vehicles.

11. The modular system of claim 6, wherein the fastening features allow the associated vehicle components to be non-destructively removed from the universal frame.

12. The modular system of claim 6, wherein the fastening features include an alignment member operable to align an associated vehicle component with other associated fastening features on the universal frame.

13. The modular system of claim 6, wherein each of the fastening features allows the vehicle components to be attached from a top or side of the frame.

14. A small utility vehicle frame comprising:
a pair of longitudinally extending metallic main members, the main members having an interior surface and an exterior surface;
at least one cross member attached to and extending between the main members;
a plurality of apertures in the main members extending from the exterior surface to the interior surface; and
an electrocoating layer disposed on an entirety of said interior and exterior surfaces of the main members and on the at least one cross member.

15. The small utility vehicle frame of claim 14, wherein the electrocoating layer has a nominal thickness of at least about 0.004 inches.

16. The small utility vehicle frame of claim 14, wherein the electrocoating layer is a corrosion-inhibiting layer.

17. The small utility vehicle frame of claim 14, wherein the main members are box-shaped in cross section.

18. The small utility vehicle frame of claim 14, wherein the apertures include threads having the electrocoating layer thereon.

19. A small utility vehicle system comprising:
a frame having a pair of longitudinally extending main members and at least one cross member extending transversely between the main members, a rear portion of the main members curving upwardly and then curving downwardly as the rear portion of the main members extends toward a rear end of the frame; and
a power unit coupled to the frame, the power unit including an internal combustion engine and a drive clutch coupled to the internal combustion engine with a retaining fastener, the retaining fastener being located in a position corresponding to the vertically curving rear portion of the main members such that the drive clutch retaining fastener is accessible from a side of the small utility vehicle and the drive clutch can be separated from the power unit without moving the entire power unit relative to the frame.

20. The small utility vehicle system of claim 19, wherein the drive clutch retaining fastener is disposed proximate a forward section of the rear portion of the main members.

21. A method of assembling a small utility vehicle comprising:
positioning vehicle components that are to be attached directly to a small utility vehicle frame on the small utility vehicle frame;
aligning attachment features on the vehicle components with fastening features on the frame; and
attaching the aligned vehicle components directly to the frame with fasteners that engage with the fastening features on the frame from either a top or side of the frame such that all of the vehicle components that are attached directly to the frame are done with fasteners that engage with the fastening features on the frame from either a top or side of the frame.

22. The method of claim 21, wherein the frame includes brackets welded thereto and aligning the fastening features includes aligning attachment features on the vehicle components with fastening features on the brackets.

23. The method of claim 21, wherein attaching aligned vehicle components includes attaching an instrument panel support assembly, a seat support assembly, a pedal assembly, a front suspension system, a rear suspension system, a power unit, a drive system, a floorboard, and a rear vehicle assembly.

24. The method of claim 21, further comprising assembling a golf car vehicle.

25. A method of assembling small utility vehicles comprising:
providing a plurality of identical universal frames that can be used to make small utility vehicles of varying configurations, the universal frames having at least two different groups of fastening features that can be used to respectively attach vehicle components from at least two different groups of vehicle components of varying configurations to the universal frames;
assemblying a first small utility vehicle of a first configuration on a first one of the universal frames, assembling the first small utility vehicle including:
(i) selecting a first vehicle component that corresponds to the first configuration from a first group of vehicle components of varying configurations that all utilize a first group of fastening features on the universal frame to be attached to the universal frame;
(ii) selecting a second vehicle component that corresponds to the first configuration from a second group of vehicle components of varying configurations that all utilize a second group of fastening features on the universal frame to be attached to the universal frame;
(iii) attaching the first and second selected vehicle components to the first universal frame;
assembling a second small utility vehicle of a second configuration different than the first configuration on a second one of the universal frames, assembling the second small utility vehicle including:
(iv) selecting a third vehicle component that corresponds to the second configuration from the first group of vehicle components of varying configurations;
(v) selecting a forth vehicle component that corresponds to the second configuration from the second group of vehicle components of varying configurations; and
(vi) attaching the third and forth selected vehicle components to the second universal frame.

26. The method of claim 25, wherein selecting the first and third vehicle components includes selecting instrument panel support assemblies of differing configurations corresponding to the respective first and second small utility vehicle configurations and selecting the second and forth vehicle components includes selecting seat support assemblies of differing configurations corresponding to the respective first and second small utility vehicle configurations.

27. The method of claim 25, wherein selecting the first and third vehicle components includes selecting instrument panel support assemblies of differing configurations corresponding to the respective first and second small utility vehicle configurations and selecting the second and forth vehicle components includes selecting rear vehicle assemblies of differing configurations corresponding to the respective first and second small utility vehicle configurations.

28. The method of claim 25, wherein assembling first and second small utility vehicles of differing configurations includes assembling at least two of a golf car, a shuttle personnel carrier, a refreshment vehicle, an industrial utility vehicle and a trail utility vehicle.

29. The method of claim 25, wherein assembling first and second small utility vehicles of differing configurations includes assembling at least one golf car.
